(19) United States
(12) Patent Application Publication
(10) Pub. No.: US 2026/0148919 A1
(43) Pub. Date: May 28, 2026

(54) RELAY VOLTAGE INPUT CONNECTION STRUCTURE AND RELAY

(71) Applicant: Xiamen Hongfa Electric Power Controls Co., Ltd., Xiamen, Fujian (CN)

(72) Inventors: Zhigang WEN, Xiamen, Fujian (CN); Shuming ZHONG, Xiamen, Fujian (CN); Wenguang DAI, Xiamen, Fujian (CN); Fangneng LI, Xiamen, Fujian (CN)

(21) Appl. No.: 19/120,935

(22) PCT Filed: Sep. 7, 2023
(86) PCT No.: PCT/CN2023/117490

§ 371 Date: Apr. 14, 2025

(30) Foreign Application Priority Data
Oct. 12, 2022 (CN) 202211249678.4

(51) Int. Cl. H01H 50/04; H01H 50/14

(52) U.S. Cl. CPC H01H 50/048; H01H 50/14

(57) ABSTRACT

A relay voltage input connection structure includes a connector assembly including a connection member, the connection member being provided with a plurality of signal plugging through holes; a plurality of relay coil pins correspondingly plugged into the plurality of signal plugging through holes; and an error-proof mounting member arranged on a housing of a relay and connected to the connection member. Wherein the error-proof mounting member is configured to limit a position of the connection member relative to the error-proof mounting member, to position the connection member.

### CROSS-REFERENCE

The present disclosure is a national stage of International PCT Application No. PCT/CN2023/117490, filed on Sep. 7, 2023, which claims priority to Chinese Patent Application No. 202211249678.4, filed on Oct. 12, 2022, the entire content of which is incorporated herein by reference in its entirety.

### TECHNICAL FIELD

The present disclosure generally relates to the technical field of electrical elements and, more particularly, to a relay voltage input connection structure and a relay.

### BACKGROUND

Lead-out terminals of coils of existing magnetic latching relays are mostly solder pins, and the solder pins of the magnetic latching relays are fixed to signal wires by soldering.

Voltage input connection structures of coils of the existing magnetic latching relays have the following drawbacks.

First, due to relatively small spacing between adjacent signal lines, in order to avoid scalding the signal lines during soldering, it is necessary to fit heat shrink tubing over the outside of the signal lines, which is a complex production process and may cause high labor costs and low degree of automation and affect the soldering efficiency.

Second, multiple signal lines have color line sequence requirements and are easy to be soldered in wrong positions, resulting in a situation that the signal lines are reversed, so that the magnetic latching relays cannot work properly and the qualification rate of finished products is diminished.

### SUMMARY

According to a first aspect of the present disclosure, there is provided a relay voltage input connection structure, including a connector assembly including a connection member, the connection member being provided with a plurality of signal plugging through holes; a plurality of relay coil pins correspondingly plugged into the plurality of signal plugging through holes; and an error-proof mounting member arranged on a housing of a relay and connected to the connection member. The error-proof mounting member is configured to limit a position of the connection member relative to the error-proof mounting member, to position the connection member.

In some embodiments of the present disclosure, the error-proof mounting member includes: a mounting portion arranged on the housing of the relay and detachably connected to the connection member; and an error-proof portion arranged on the mounting portion and configured to limit a position of the connection member relative to the mounting portion.

In some embodiments of the present disclosure, the connection member is provided with an insertion hole corresponding to the error-proof portion, and the error-proof portion passes through the insertion hole and contacts the insertion hole in a contact fit.

In some embodiments of the present disclosure, the plurality of relay coil pins are arranged along a first direction, and distances from two ends of the mounting portion along the first direction to the error-proof portion are not equal.

In some embodiments of the present disclosure, the connection member includes: a positioning portion detachably connected to the mounting portion, the insertion hole is in the positioning portion; and a connection portion connected to the positioning portion, the signal plugging through holes is disposed in the connection portion.

In some embodiments of the present disclosure, one of the positioning portion and the mounting portion is provided with a hook, and the another one of the positioning portion and the mounting portion is provided with a snap, the hook is engaged with the snap.

In some embodiments of the present disclosure, a receiving chamber is provided at a side of the positioning portion facing the error-proof mounting member, and the receiving chamber is configured to receive the mounting portion, to allow a connection position between the hook and the snap to be within the positioning portion.

In some embodiments of the present disclosure, the hook is on the mounting portion along a height direction of the housing of the relay; or the snap is on the mounting portion along the height direction of the housing of the relay.

In some embodiments of the present disclosure, there are a plurality of hooks and a plurality of snaps, the plurality of hooks are correspondingly connected to the plurality of snaps; the plurality of hooks are arranged at both sides of the mounting portion along the height direction of the housing of the relay.

In some embodiments of the present disclosure, the connector assembly further includes a plurality of signal lines arranged along a first direction, and the plurality of signal lines are correspondingly plugged into the signal plugging through holes along a second direction and electrically connected to the plurality of relay coil pins; the first direction and the second direction are perpendicular to each other.

In some embodiments of the present disclosure, the error-proof mounting member extends along the first direction and is arranged side by side with the relay coil pins along a third direction; the third direction is perpendicular to both the first direction and the second direction.

In some embodiments of the present disclosure, the signal lines are detachably connected to the connection member.

According to a first aspect of the present disclosure, there is provided a relay, including a housing, a coil, and the relay voltage input connection structure; the coil is arranged within the housing, and the relay coil pins of the relay voltage input connection structure form a lead-out terminal of the coil.

In some embodiments of the present disclosure, the error-proof mounting member of the relay voltage input connection structure and the housing of the relay are of an integrally formed structure.

In some embodiments of the present disclosure, the relay further includes a load terminal, and the load terminal is at least partially arranged within the housing.

In some embodiments of the present disclosure, a first side plate is perpendicularly arranged on the bottom plate, the load terminal is at least partially led out from the first side plate; and a second side plate is perpendicularly arranged on the bottom plate, the second side plate is adjacent to and perpendicular to the first side plate. The error-proof mounting member of the relay voltage input connection structure is arranged on the second side plate.

In some embodiments of the present disclosure, the second side plate is provided with a recessed portion, and the error-proof mounting member is arranged in the recessed portion.

### BRIEF DESCRIPTION OF THE DRAWINGS

The above and other features and advantages of the present disclosure will become more apparent by describing in detail exemplary embodiments with reference to the accompanying drawings.

FIG. 1 is a structural schematic view of a relay voltage input connection structure according to an embodiment of the present disclosure from one angle of view;

FIG. 2 is a structural schematic view of a relay voltage input connection structure according to an embodiment of the present disclosure from another angle of view;

FIG. 3 is a structural schematic view of a relay voltage input connection structure according to an embodiment of the present disclosure from yet another angle of view;

FIG. 4 is an enlarged partial view of part A in FIG. 3;

FIG. 5 is a structural schematic view of a relay voltage input connection structure with an error-proof mounting member shown according to an embodiment of the present disclosure;

FIG. 6 is a first structural schematic view of a relay voltage input connection structure with a connector assembly shown according to an embodiment of the present disclosure;

FIG. 7 is a second structural schematic view of a relay voltage input connection structure with a connector assembly shown according to an embodiment of the present disclosure;

FIG. 8 is a third structural schematic view of a relay voltage input connection structure with a connector assembly shown according to an embodiment of the present disclosure;

FIG. 9 is a fourth structural schematic view of a relay voltage input connection structure with a connector assembly shown according to an embodiment of the present disclosure

FIG. 10 is a fifth structural schematic view of a relay voltage input connection structure with a connector assembly shown according to an embodiment of the present disclosure;

FIG. 11 is a schematic view showing cooperation between a connector assembly and a relay coil pin of a relay voltage input connection structure according to an embodiment of the present disclosure.

### REFERENCE NUMERALS

100. housing; 101. bottom plate; 102. first side plate; 103. second side plate; 1031. through slot; 1. relay coil pin; 2. connector assembly; 3. error-proof mounting member; 21. connection member; 211. positioning portion; 2111. insertion hole; 2112. hook; 2113. receiving chamber; 212. connection portion; 2121. snap hole; 2122. signal plugging through hole; 2123. lock tongue; 22. signal line; 31. mounting portion; 311. snap; 32. error-proof portion.

### DETAILED DESCRIPTION

Technical solutions in exemplary embodiments of the present disclosure will be described clearly and thoroughly in conjunction with the accompanying drawings associated with the exemplary embodiments of the present disclosure. The exemplary embodiments described herein are only for illustrative purposes and are not intended to limit the protection scope of the present disclosure. It should be understood that various modifications and changes may be made to the exemplary embodiments without departing from the protection scope of the present disclosure.

In the description of the present disclosure, unless expressly specified and limited otherwise, terms such as “first” and “second” are used herein for purposes of description and are not intended to indicate or imply relative importance; the term “a plurality of” means two or more than two; the term “and/or” includes any and all possible combinations of one or more associated listed items. In particular, references to “the/said” object or “an” object are intended to represent one of a possible plurality of such objects.

Unless specified or indicated otherwise, terms “connected,” “fixed” and the like are used broadly. For example, the term “connected” may refer to fixed connections, detachable connections, or integral connections; may refer to electrical connections or signal connections; may also refer to direct connections or indirect connections via intervening structures, which may be understood by those skilled in the art according to specific situations.

Further, in the description of the present disclosure, it should be understood that orientation terms such as “upper,” “lower,” “inner” and “outer” in the exemplary embodiments of the present disclosure refer to orientations as shown in the drawings under discussion and should not be construed as limiting the exemplary embodiments of the present disclosure. It is also to be understood that in the context, an element or feature being connected “above,” “below,” “inside” or “outside” another element (one or more) means that the element or feature may be directly connected “above,” “below,” “inside” or “outside” another element (one or more) or may be indirectly connected “above,” “below,” “inside” or “outside” another element (one or more) through an intermediate element.

Exemplary embodiments will now be described more fully with reference to the drawings. However, the exemplary embodiments may be implemented in various forms and should not be understood as being limited to the implementations set forth herein; rather, these embodiments allow the present disclosure to be comprehensive and complete, and the concept of the exemplary embodiments can be fully conveyed to those skilled in the art. The same reference numerals in the drawings denote the same or similar structures, which will not be elaborated again.

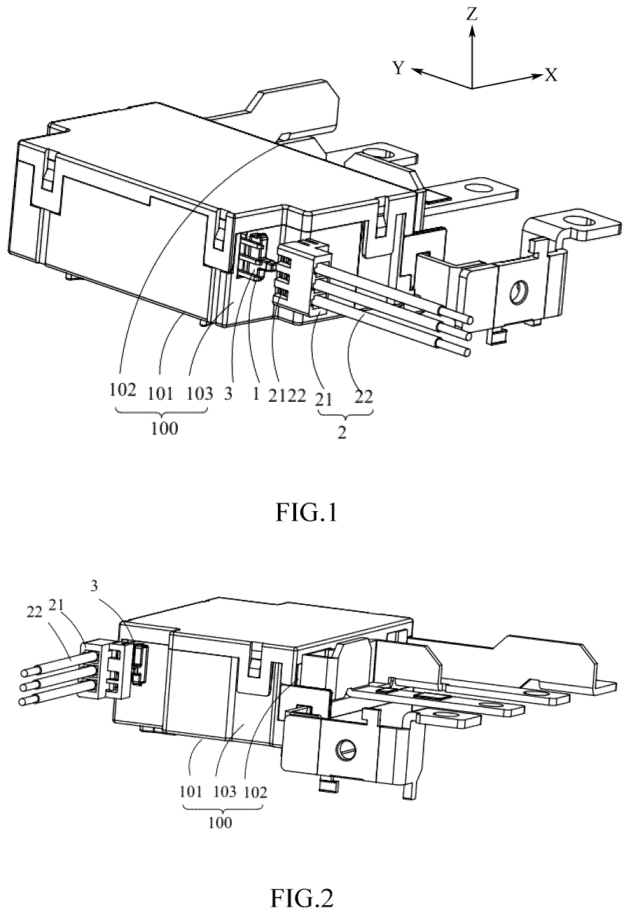

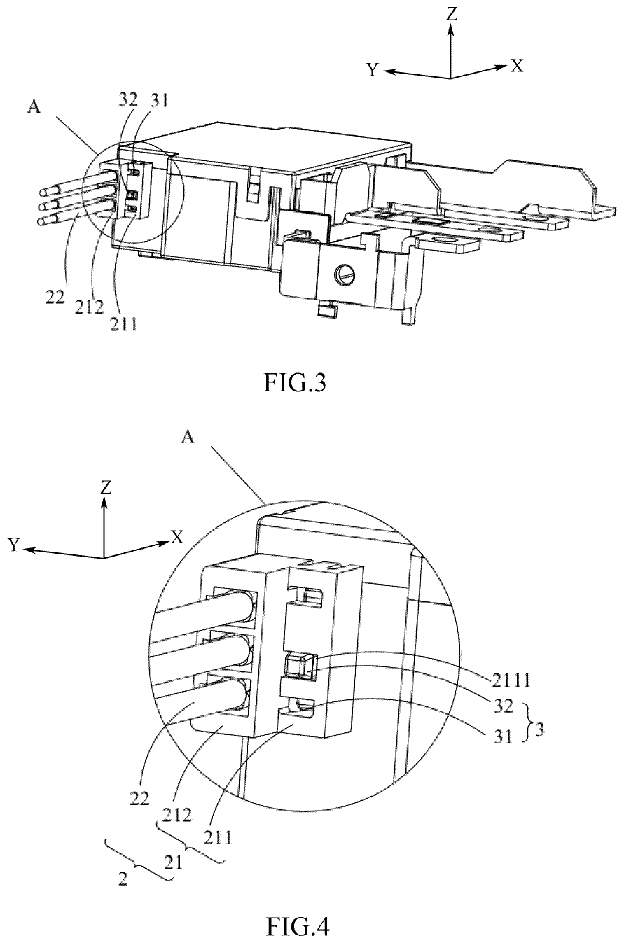

Embodiments of the present disclosure provide a relay voltage input connection structure suitable for the technical field of relays. As shown in FIGS. 1-3, the relay voltage input connection structure includes a connector assembly 2 and a plurality of relay coil pins 1. The plurality of relay coil pins 1 essentially serve as a lead-out terminal of a relay coil. The connector assembly 2 includes a connection member 21, and the connection member 21 is provided with a plurality of signal plugging through holes 2122. The plurality of relay coil pins 1 are correspondingly plugged into the plurality of signal plugging through holes 2122.

For the relay voltage input connection structure according to the embodiments, the signal plugging through holes 2122 provide mounting positions for the relay coil pins 1, and the relay coil pins 1 play a role in voltage transmission. After the relay coil pins 1 are plugged into the signal plugging through holes 2122, a voltage signal may be transmitted to the coil through the relay coil pins 1, causing the coil to generate a magnetic field change under charging.

It should be noted that the shape of the connection member 21 is similar to a rectangular prism structure, a height direction of the connection member 21 being defined as a first direction Z, a length direction of the connection member 21 being defined as a second direction Y, and a width direction of the connection member 21 being defined as a third direction X, in which the first direction Z, the second direction Y, and the third direction X are perpendicular to each other. The plurality of relay coil pins 1 are arranged along the first direction Z; in other words, an arrangement direction of the plurality of relay coil pins 1 is the first direction Z.

In one embodiment, the connector assembly 2 further includes a plurality of signal lines 22 arranged along the first direction Z, and the plurality of signal lines 22 are correspondingly plugged into the signal plugging through holes 2122 along the second direction Y and electrically connected to the plurality of relay coil pins 1. The signal plugging through holes 2122 provide mounting positions for the signal lines 22, and the signal lines 22 play a role in voltage transmission. The signal lines 22 and the relay coil pins 1 are respectively arranged at both sides of the connection member 21 along the second direction Y, so that after the signal lines 22 and the relay coil pins 1 are plugged into the signal plugging through holes 2122, the electrical connection between the signal lines 22 and the relay coil pins 1 may be achieved, allowing the voltage signal to be transmitted to the coil through the signal lines 22 and the relay coil pins 1, and causing the coil to generate the magnetic field change under charging.

It may be understood that since the plurality of signal lines 22 are arranged along the first direction Z, that is, the plurality of signal lines 22 are arranged in a certain sequence on the connection member 21, so that the plurality of signal lines 22 and the plurality of relay coil pins 1 are correspondingly arranged and electrically connected to each other, to realize a process of voltage transmission.

In the related art, heat shrink tubing is fitted over the outside of the signal lines, and the signal line and the relay coil pin are connected by soldering, which is a complex production process with low production efficiency; moreover, the plurality of signal lines are easy to be mixed up and reversed, which may affect effectiveness of a relay.

In order to solve the above problems, as shown in FIGS. 1-3, the relay voltage input connection structure according to embodiments of the present disclosure further includes an error-proof mounting member 3, which is arranged on a housing 100 of the relay and connected to the connection member 21. The error-proof mounting member 3 is configured to limit a position of the connection member 21 relative to the error-proof mounting member 3, to position the connection member 21, so that the plurality of signal lines 22 are correspondingly electrically connected to the plurality of relay coil pins 1.

For the relay voltage input connection structure according to embodiments of the present disclosure, the error-proof mounting member 3 is arranged on the housing 100 of the relay and connected to the connection member 21, and the error-proof mounting member 3 plays a role in mounting the connection member 21, to fix the connector assembly 2 to the housing 100 of the relay. The error-proof mounting member 3 limits the position of the connection member 21 relative to the error-proof mounting member 3, and plays a role in limiting and positioning the position of the connection member 21. The error-proof mounting member 3 may interfere with the position of the connection member 21 to achieve an error-proof function, that is, the connection member 21 can be connected to the error-proof mounting member 3 only at a specific position, which is equivalent to restricting positions of the plurality of signal plugging through holes 2122 arranged on the connection member 21, so as to ensure unicity of an arrangement sequence of the plurality of relay coil pins 1, and avoid incorrect connection caused by confusion, thereby improving the qualification rate of relay products.

It may be understood that after the plurality of signal plugging through holes 2122 are positionally constrained by using the error-proof mounting member 3, since the plurality of signal lines 22 are correspondingly plugged into the plurality of signal plugging through holes 2122, it is equivalent to constraining the positions of the plurality of signal lines 22, which may ensure unicity of an arrangement sequence of the plurality of signal lines 22, so that the plurality of signal lines 22 may be correspondingly electrically connected to the plurality of relay coil pins 1, reducing the occurrence of incorrect connection caused by chaotic sequence of the signal lines 22, and resulting in a higher qualification rate of relay products.

In one embodiment, the error-proof mounting member 3 extends along the first direction Z and is arranged side by side with the relay coil pins 1 along the third direction X.

The error-proof mounting member 3 extends along the first direction Z, so that an error-proof direction of the error-proof mounting member 3 is consistent with the arrangement direction of the plurality of relay coil pins 1, thereby avoiding a situation that the plurality of signal lines 22 are plugged in incorrectly. Meanwhile, the error-proof mounting member 3 and the relay coil pins 1 are arranged side by side along the third direction X, which is equivalent to the error-proof mounting member 3 being located at a side of the relay coil pins 1, so that the error-proof mounting member 3 may prevent incorrect plugging while avoiding interference with the positions of the relay coil pins 1.

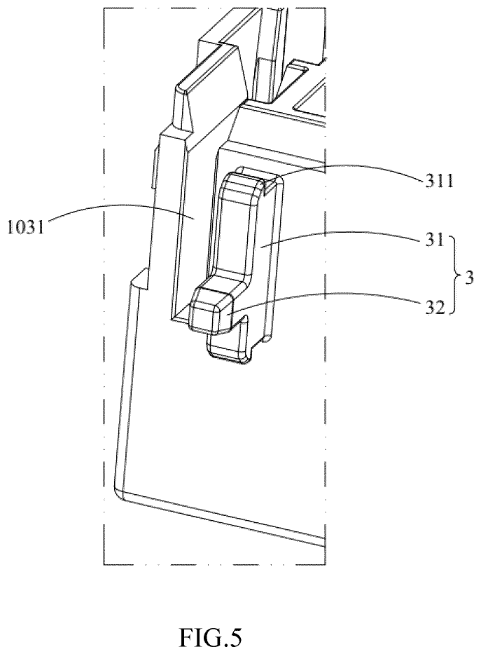

In one embodiment, as shown in FIGS. 4-5, the error-proof mounting member 3 includes a mounting portion 31 and an error-proof portion 32. The mounting portion 31 is arranged on the housing 100 of the relay and is detachably connected to the connection member 21. The error-proof portion 32 is arranged on the mounting portion 31 and is configured to limit the position of the connection member 21 relative to the mounting portion 31.

The mounting portion 31 is of a bar-shaped structure and is fixed to the housing 100 of the relay. The mounting portion 31 is detachably connected to the connection member 21, and functions to prevent disengagement of the connection member 21 and and fixing the connection member 21, so as to ensure the positional stability of the connector assembly 2. The error-proof portion 32 functions to limit and locate the position of the connection member 21, so that the connection member 21 is restricted in such a way that it can be connected to the mounting portion 31 only at a specific position, thereby realizing positioning and error-proof functions, and reducing the confusion and incorrect connection of the signal lines 22.

In one embodiment, the connection member 21 is provided with an insertion hole 2111 corresponding to the error-proof portion 32, and the error-proof portion 32 passes through the insertion hole 2111 and contacts it in a contact fit.

The error-proof portion 32 specifically has a columnar structure and may be referred to as a positioning column. Since the connection member 21 is provided with the insertion hole 2111 corresponding to the error-proof portion 32, the error-proof portion 32 may pass through the insertion hole 2111 and contacts it in a contact fit, so as to play a guiding role and meanwhile realize a function of initial pre-positioning between the connector assembly 2 and the error-proof mounting member 3 during installation of the connector assembly 2, thereby ensuring precision of the mounting position of the connector assembly 2.

It should be noted that the error-proof portion 32 may be a square column or a round column, and the insertion hole 2111 may be a square hole or a round hole; the structures and shapes of the error-proof portion 32 and the insertion hole 2111 are not limited in embodiments of the present disclosure, and may be adjusted according to actual production conditions, as long as the error-proof portion 32 and the insertion hole 2111 are fitted with each other, all of which fall into the protection scope of embodiments of the present disclosure.

It should be noted that an end of the error-proof portion 32 at a side close to the connector assembly 2 may be of a tapered structure, that is, the end of the error-proof portion 32 may be called a tip portion, which facilitates the insertion of the error-proof portion 32 into the insertion hole 2111.

It should be noted that the arrangement direction of the plurality of signal lines 22 is the first direction Z, and the first direction Z may be along the height, length or width direction of the housing 100 of the relay. For example, the first direction Z is taken as the height direction of the housing 100 in the embodiments of the present disclosure, and the connector assembly 2 is connected to the lead-out terminal of the coil by transverse insertion.

In one embodiment, the plurality of relay coil pins 1 are arranged along the first direction Z, and a distance between one end of the mounting portion 31 along the first direction Z and the error-proof portion 32 is not equal to a distance between the other end thereof along the first direction Z and the error-proof portion 32.

If the error-proof portion 32 is arranged at a center position of the mounting portion 31, regardless of whether the connection member 21 is upright or inverted, the error-proof portion 32 can be inserted into the insertion hole 2111 of the connection member 21, and the position of the connection member 21 relative to the error-proof portion 32 is not significantly different, so that the error-proof function can be hardly realized. By designing the distances from the two ends of the mounting portion 31 along the first direction Z to the error-proof portion 32 to be unequal, that is, the error-proof portion 32 is not arranged at the center position of the mounting portion 31 along the first direction Z, the error-proof mounting member 3 and the connection member 21 can only be connected smoothly when the connection member 21 is in only one of the upright and inverted states, which means that the connection member 21 is in a correct mounting position. Otherwise, even if the error-proof portion 32 is partially inserted into the insertion hole 2111, the connection member 21 may protrude beyond the mounting portion 31 at some positions or the connection member 21 may be within the mounting portion 31 at other positions, which means that at least a partial structure of the connection member 21 cannot perfectly fit with the mounting portion 31, i.e., the connection member 21 is in an incorrect mounting position and needs to change its direction by rotating 180°.

It should be noted that in some other embodiments, if the plurality of signal lines 22 are arranged along the second direction Y, such as a length direction of the housing 100 of the relay, that is, the second direction Y, the first direction Z and the second direction Y are perpendicular to each other, distances from two ends of the mounting portion 31 along the second direction Y to the error-proof portion 32 are not equal, of which the principle and structure are similar and will not be described in detail.

In one embodiment, as shown in FIGS. 4-5, the connection member 21 includes a positioning portion 211 and a connection portion 212. The positioning portion 211 is detachably connected to the mounting portion 31, and the connection portion 212 is connected to the positioning portion 211. The insertion hole 2111 is in the positioning portion 211, and the signal plugging through holes 2122 are in the connection portion 212, that is, connection positions between the signal lines 22 and the relay coil pins 1 are within the connection portion 212.

The insertion hole 2111 is in the positioning portion 211, and the positioning portion 211 provides a setting position for the insertion hole 2111. The positioning portion 211 is detachably connected to the mounting portion 31, and essentially functions to be mounted with the error-proof mounting member 3. The connection portion 212 is connected to the positioning portion 211, so that the connection portion 212 and the positioning portion 211 form an integrated structure. The signal lines 22 and the relay coil pins 1 are respectively on both sides of the connection portion 212 along the second direction Y. After the error-proof portion 32 is inserted into the insertion hole 2111, the signal lines 22 and the relay coil pins 1 may be directly docked, and the connection portion 212 serves as an intermediate connection between the signal lines 22 and the relay coil pins 1. Meanwhile, the signal lines 22 and the relay coil pins 1 are on different sides of the connection portion 212 along the second direction Y, reducing interference between the signal lines 22 and the relay coil pins 1. The connection positions between the signal lines 22 and the relay coil pins 1 are hidden within the connection portion 212, avoiding a situation where the connection positions between the signal lines 22 and the relay coil pins 1 are exposed; the connection portion 212 serves as a connection support seat while providing dust-proof and protection.

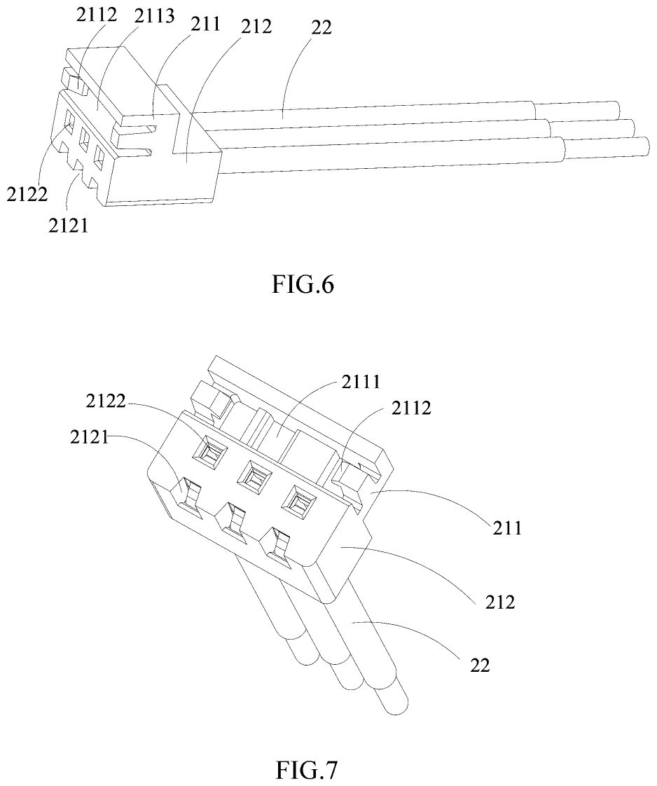

In one embodiment, as shown in FIGS. 5-6, one of the positioning portion 211 and the mounting portion 31 is provided with a hook 2112, and the other thereof is provided with a snap 311; the hook 2112 is engaged with the snap 311.

Compared with the existing soldering and fixing methods, the present disclosure achieves the detachable connection between the positioning portion 211 and the mounting portion 31 by the fit between the hook 2112 and the snap 311. Consequently, the connection stability is good; it is convenient for installation and disassembly and easy for subsequent maintenance; the structure is simple and the operation is convenient, without the need for additional installation of heat shrink tubing and other operations, thereby saving labor and time costs, and improving the productivity of installation.

It should be noted that the hook 2112 or the snap 311, the mounting portion 31, and the error-proof portion 32 may be of an integrally formed structure, which means that an overall structure of the error-proof mounting member 3 may be formed in one go, simplifying an assembly process of parts and reducing production costs.

In one embodiment, as shown in FIG. 6, a receiving chamber 2113 is provided at a side of the positioning portion 211 facing the error-proof mounting member 3. The receiving chamber 2113 is configured to receive the mounting portion 31, so that a connection position between the hook 2112 and the snap 311 is within the positioning portion 211.

The receiving chamber 2113 is provided at the side of the positioning portion 211 facing the error-proof mounting member 3, and the receiving chamber 2113 provides a receiving space for the mounting portion 31. When the mounting portion 31 is accommodated in the receiving chamber 2113, it is equivalent to the mounting portion 31 being embedded in the positioning portion 211, which has a compact structure and occupies less space compared with a structure that the mounting portion 31 is exposed relative to the positioning portion 211. The connection position between the hook 2112 and the snap 311 is within the positioning portion 211, which may prevent the connection position between the hook 2112 and the snap 311 from being exposed or protruding and occupying a large space, and may save space.

Embodiments of the present disclosure elaborate, by way of an example where the mounting portion 31 is provided with the snap 311 and the positioning portion 211 is provided with the hook 2112, how to fully utilize internal space of the mounting portion 31 and improve space utilization.

In one embodiment, the error-proof mounting member 3 of the relay voltage input connection structure and the housing 100 of the relay are integrally formed. Since the error-proof mounting member 3 and the housing 100 of the relay are of an integrally formed structure, the assembly process and time of parts are reduced, and the production costs are lowered.

It may be understood that the mounting portion 31 and the error-proof portion 32 of the error-proof mounting member 3 are also of an integrally formed structure.

It may be understood that the housing 100 of the relay is made of insulating materials such as plastic, then the housing 100 and the error-proof mounting member 3 are integrally formed by injection molding, simplifying the assembly process of parts, improving the degree of automated production, and saving production costs.

In an actual production process, when a molded part includes a side hole, a side indentation, or a protrusion that is different from a mold opening direction, a protruding portion of the molded part may hinder demolding of the molded part.

Therefore, the hook 2112 in the embodiments of the present disclosure is on the mounting portion 31 along the height direction of the housing 100 of the relay; alternatively, the snap 311 is on the mounting portion 31 along the height direction of the housing 100 of the relay.

The height direction of the housing 100 is the first direction Z, which is an opening and closing direction of upper and lower molds. If the hook 2112 is arranged on the mounting portion 31, the hook 2112 is arranged along the height direction of the housing 100, rather than along the length or width direction of the housing 100. If the snap 311 is arranged on the mounting portion 31, the snap 311 is arranged along the height direction of the housing 100, rather than along the length or width direction of the housing 100. In such a way, the arrangement direction of the hook 2112 or the snap 311 is consistent with the opening direction of the upper and lower molds, so that the molds do not need any side pulling structure or slider structure while the integrated molding of the error-proof mounting member 3 and the housing 100 is realized, which makes the structure of the upper and lower molds simple and lowers the production costs.

In one embodiment, there are a plurality of hooks 2112 and a plurality of snaps 311, with the plurality of hooks 2112 correspondingly fitted with the plurality of snaps. The plurality of hooks 2112 are arranged at both sides of the mounting portion 31 along the height direction of the housing 100 of the relay.

The plurality of hooks 2112 are correspondingly fitted with the plurality of snaps 311, forming a plurality of snap points between the error-proof mounting member 3 and the connector assembly 2, which enhances the connection stability between the error-proof mounting member 3 and the connector assembly 2. By providing the plurality of hooks 2112 at both sides of the mounting portion 31 along the first direction Z, the arrangement direction of hooks 2112 and snaps 311 is consistent with the opening and closing direction of the upper and lower molds, simplifying the molds and the production process, and lowering the production costs.

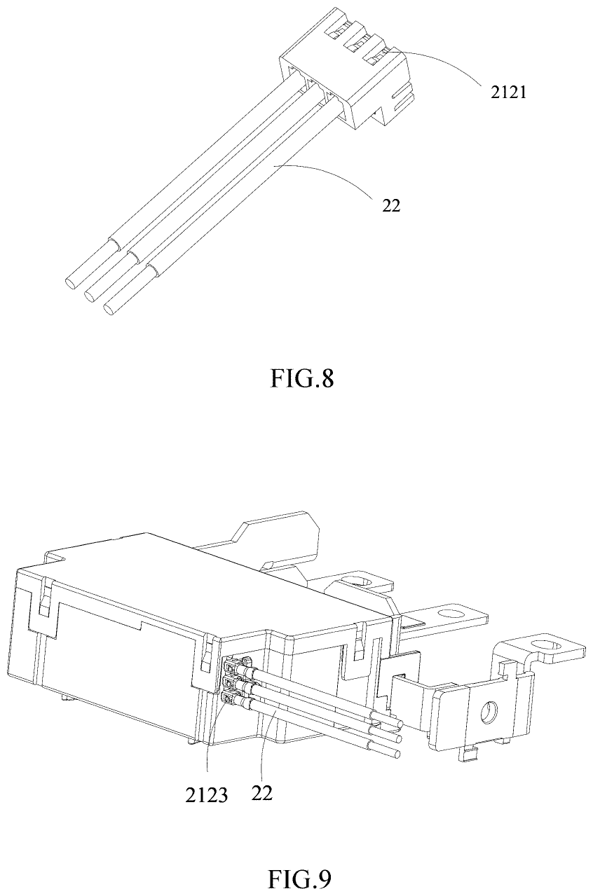

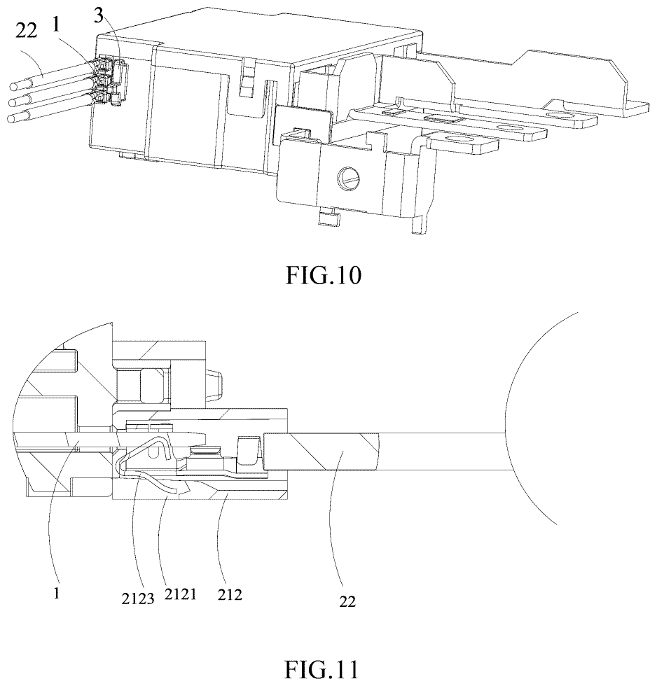

In one embodiment, as shown in FIGS. 7-11, the signal lines 22 are detachably connected to the connection portion 212, which facilitates installation and removal of the signal lines 22. The connections of individual signal lines 22 are relatively independent, which facilitate maintenance in the event of damage during use.

Specifically, a connection terminal is provided at an end of the signal line 22, and is provided with the signal plugging through hole 2122. When the relay coil pin 1 passes through the signal plugging through hole 2122, the relay coil pin 1 and a flexible wire of the signal line 22 come into contact with each other to achieve electrical conductivity between the relay coil pin 1 and the signal line 22. Inside the connection terminal, there is a lock tongue 2123, which has a shape similar to a V-shaped structure; two side arms of the V-shaped structure abut against the relay coil pin 1 and the connection portion 212, respectively. Since one side arm of the V-shaped structure abuts against the relay coil pin 1, the position of the relay coil pin 1 may be fixed, to ensure the reliability of the connection between the relay coil pin 1 and the flexible wire of the signal line 22. The connection portion 212 is provided with a snap hole 2121 corresponding to the lock tongue 2123, and the other side arm of the V-shaped structure is clamped to the snap hole 2121 to ensure the fixation between the lock tongue 2123 and the connection portion 212. It may be understood that due to a certain degree of elasticity of the lock tongue 2123 of the V-shaped structure, under an elastic action of the lock tongue 2123 itself, a fixing effect of the lock tongue 2123 with the relay coil pin 1 and the connection portion 212 can be ensured simultaneously.

It may be understood that the installation and fixing process of the signal line 22 eliminates the need for heat shrink tubing and soldering wires, which results in fewer production personnel and a high production qualification rate.

Embodiments of the present disclosure also provide a relay, includes a housing 100, a coil, and the aforementioned relay voltage input connection structure. The coil is arranged within the housing 100, and the relay coil pins 1 of the relay voltage input connection structure essentially form a lead-out terminal of the coil.

For the relay according to the embodiments of the present disclosure, since the coil is arranged within the housing 100, the housing 100 serves to accommodate and protect the coil.

It should be noted that the relay is specifically an electromagnetic relay, and also includes a contact assembly, an electromagnetic assembly, an armature assembly, and a push card. A permanent magnet inside the armature assembly has a magnetic attraction effect to keep the contact assembly in a normally open or a normally closed state. Since the signal line 22 is correspondingly electrically connected to the relay coil pin 1 to transmit the voltage signal to the coil, relying on a pulse electrical signal trigger, the electromagnetic assembly drives the armature assembly to drive the push card to displace; and due to the displacement of the push card, the contact assembly switches between the normally open state and the normally closed state.

In one embodiment, the relay further includes a load terminal, which is at least partially arranged within the housing 100.

The contact assembly includes a movable contact piece and a static contact leading-out terminal. One end of the movable contact piece and one end of the static contact leading-out terminal are in contact with or away from each other to switch between the normally open state or the normally closed state. The load terminal is separately connected to the other end of the movable contact piece and the other end of the static contact leading-out terminal. When one end of the movable contact piece and one end of the static contact leading-out terminal are in contact with each other, the movable contact piece, the static contact leading-out terminal, and the load terminal form a closed circuit.

In one embodiment, as shown in FIGS. 1-2, the housing 100 includes a bottom plate 101, a first side plate 102, and a second side plate 103. The first side plate 102 is perpendicularly arranged on the bottom plate 101, and the load terminal is at least partially led out from the first side plate 102. The second side plate 103 is perpendicularly arranged on the bottom plate 101, and the first side plate 102 and the second side plate 103 are adjacent and perpendicular to each other. The error-proof mounting member 3 of the relay voltage input connection structure is arranged on the second side plate 103.

The first side plate 102 and the second side plate 103 are perpendicularly arranged on the bottom plate 101 and surrounded the bottom plate 101, so that the housing 100 provides an accommodation space required by the coil and other components, and provides protection for these components. By installing the error-proof mounting member 3 on the second side plate 103, the load terminal may be at least partially led out from the first side plate 102, which is equivalent to the load terminal and the error-proof mounting member 3 corresponding to two adjacent side plates. Since both the load terminal and the error-proof mounting member 3 protrude from the housing 100, the load terminal and the error-proof mounting member 3 are correspondingly arranged on the adjacent side plates, reducing the space occupied by the load terminal and the error-proof mounting member 3 along the third direction X and achieving a reduction in the height dimension of the relay.

Meanwhile, the second side plate 103 is provided with a through slot 1031 (as shown in FIG. 5), and the relay coil pin 1 passes through the through slot 1031, so that the relay coil pin 1 is led out from the second side plate 103, and the error-proof mounting member 3 corresponds to the second side plate 103 adjacent to the lead-out terminal of the coil. According to the principle of proximity, it is convenient for the relay coil pin 1 at the lead-out terminal of the coil to be led out from the housing 100. In addition, the through slot 1031 and the error-proof mounting member 3 are arranged side by side along the third direction X, and the mold structure is simple without need for core pulling.

It may be understood that the load terminal and the relay coil pin 1 are led out from the two adjacent side plates, i.e., from the first side plate 102 and the second side plate 103, respectively, so that the structure is compact and occupies small space.

In one embodiment, the second side plate 103 is provided with a recessed portion, and the error-proof mounting member 3 is arranged in the recessed portion. The recessed portion provides at least part of an accommodation space for the error-proof mounting member 3. By utilizing internal space of the recessed portion, a protruding distance of the error-proof mounting member 3 relative to the second side plate 103 along the second direction Y is reduced, and hence the size of the entire relay along the second direction Y is further reduced.

It should be noted that the error-proof mounting member 3 of the relay voltage input connection structure extends along the first direction Z, the arrangement direction of the plurality of signal lines 22 is the first direction Z, and the first direction Z is perpendicular to the base plate 101, in which case the arrangement direction of the error-proof mounting member 3 is consistent with the opening and closing direction of the molds, simplifying the demolding process and simplifying the molds.

For the relay voltage input connection structure according to the embodiments, the signal plugging through holes provide mounting positions for the relay coil pins, and the relay coil pins play a role in voltage transmission. After the relay coil pins are plugged into the signal plugging through holes, a voltage signal may be transmitted to the coil through the relay coil pins, causing the coil to generate a magnetic field change under charging. The error-proof mounting member is arranged on the housing of the relay and connected to the connection member, and the error-proof mounting member plays a role in mounting the connection member and may fix the connector assembly to the housing of the relay. The error-proof mounting member limits the position of the connection member relative to the error-proof mounting member, and plays a role in limiting and positioning the position of the connection member. The error-proof mounting member may interfere with the position of the connection member to achieve an error-proof function, that is, the connection member can be connected to the error-proof mounting member only at a specific position, which is equivalent to restricting positions of the plurality of signal plugging through holes arranged on the connection member, so as to ensure unicity of an arrangement sequence of the plurality of relay coil pins, and avoid incorrect connection caused by confusion, thereby improving the qualification rate of relay products.

For the relay according to the embodiments of the present disclosure, since the coil is arranged within the housing, the housing serves to accommodate and protect the coil. The signal plugging through holes provide mounting positions for the relay coil pins, and the relay coil pins play a role in voltage transmission. After the relay coil pins are plugged into the signal plugging through holes, a voltage signal may be transmitted to the coil through the relay coil pins, causing the coil to generate a magnetic field change under charging. The error-proof mounting member is arranged on the housing of the relay and connected to the connection member, and the error-proof mounting member plays a role in mounting the connection member and may fix the connector assembly to the housing of the relay. The error-proof mounting member limits the position of the connection member relative to the error-proof mounting member, and plays a role in limiting and positioning the position of the connection member. The error-proof mounting member may interfere with the position of the connection member to achieve an error-proof function, that is, the connection member can be connected to the error-proof mounting member only at a specific position, which is equivalent to restricting positions of the plurality of signal plugging through holes arranged on the connection member, so as to ensure unicity of an arrangement sequence of the plurality of relay coil pins, and avoid incorrect connection caused by confusion, thereby improving the qualification rate of relay products.

It should be noted that the relay voltage input connection structure illustrated in the drawings and described in this specification is merely an example that adopt the principles of the present disclosure. Those skilled in the art should clearly understand that the principles of the present disclosure are not limited to any details or components of the device shown in the drawings or described in the specification.

It should be understood that the present disclosure does not limit its application to the detailed structures and arrangements of the components presented in this specification. The present disclosure may have other implementations and may be realized and performed in various ways. The aforementioned variations and modifications fall within the scope of the present disclosure. It should be understood that the present disclosure disclosed and limited in this specification may extends to all alternative combinations of two or more individual features mentioned or apparent in the text and/or in the drawings. All of these different combinations constitute a plurality of alternative aspects of the present disclosure. The embodiments described in the specification elaborate optimal modes of implementing the present disclosure and enable those skilled in the art to utilize the present disclosure.

Other embodiments of the present disclosure will be conceivable to those skilled in the art upon consideration of the specification and practice of the inventions disclosed herein. The present disclosure is intended to encompass any variations, uses, or adaptations of the present disclosure, which follow the general principles of the present disclosure and include common knowledge or conventional technical means in the art that are not disclosed in the present disclosure. The specification and embodiments are considered to be merely exemplary, and the true scope and spirit of the present disclosure are indicated by the appended claims.

It should be understood that the present disclosure is not limited to the precise structures described above and shown in the drawings, and various modifications and changes may be made without departing from its scope. The protection scope of the present disclosure is limited only by the appended claims.

1. A relay voltage input connection structure, comprising:
a connector assembly, comprising a connection member, the connection member being provided with a plurality of signal plugging through holes;
a plurality of relay coil pins correspondingly plugged into the plurality of signal plugging through holes; and
an error-proof mounting member arranged on a housing of a relay and connected to the connection member,
wherein the error-proof mounting member is configured to limit a position of the connection member relative to the error-proof mounting member, to position the connection member.

2. The relay voltage input connection structure according to claim 1, wherein the error-proof mounting member comprises:
a mounting portion arranged on the housing of the relay and detachably connected to the connection member; and
an error-proof portion arranged on the mounting portion and configured to limit a position of the connection member relative to the mounting portion.

3. The relay voltage input connection structure according to claim 2, wherein the connection member is provided with an insertion hole corresponding to the error-proof portion, and the error-proof portion passes through the insertion hole and contacts the insertion hole in a contact fit.

4. The relay voltage input connection structure according to claim 3, wherein the plurality of relay coil pins are arranged along a first direction, and distances from two ends of the mounting portion along the first direction to the error-proof portion are not equal.

5. The relay voltage input connection structure according to claim 3, wherein the connection member comprises:
a positioning portion detachably connected to the mounting portion, the insertion hole is in the positioning portion; and
a connection portion connected to the positioning portion, the signal plugging through holes (2122) is disposed in the connection portion.

6. The relay voltage input connection structure according to claim 5, wherein one of the positioning portion and the mounting portion is provided with a hook, and another one of the positioning portion and the mounting portion is provided with a snap, the hook is engaged with the snap.

7. The relay voltage input connection structure according to claim 6, wherein a receiving chamber is provided at a side of the positioning portion facing the error-proof mounting member, and the receiving chamber is configured to receive the mounting portion, to allow a connection position between the hook and the snap to be within the positioning portion.

8. The relay voltage input connection structure according to claim 6, wherein the hook is on the mounting portion along a height direction of the housing of the relay; or,
the snap is on the mounting portion along the height direction of the housing of the relay.

9. The relay voltage input connection structure according to claim 8, wherein there are a plurality of hooks and a plurality of snaps, the plurality of hooks are correspondingly connected to the plurality of snaps;
the plurality of hooks are arranged at both sides of the mounting portion along the height direction of the housing of the relay.

10. The relay voltage input connection structure according to claim 6, wherein the hook or the snap on the mounting portion, the mounting portion and the error-proof portion are of an integrally formed structure.

11. The relay voltage input connection structure according to claim 1, wherein the connector assembly further comprises a plurality of signal lines arranged along a first direction, and the plurality of signal lines are correspondingly plugged into the signal plugging through holes along a second direction and electrically connected to the plurality of relay coil pins;
wherein the first direction and the second direction are perpendicular to each other.

12. The relay voltage input connection structure according to claim 11, wherein the error-proof mounting member extends along the first direction and is arranged side by side with the relay coil pins along a third direction;
wherein the third direction is perpendicular to both the first direction and the second direction.

13. The relay voltage input connection structure according to claim 11, wherein the signal lines are detachably connected to the connection member.

14. A relay, comprising a housing, a coil, and the relay voltage input connection structure according to claims 1, wherein the coil is arranged within the housing, and the relay coil pins of the relay voltage input connection structure form a lead-out terminal of the coil.

15. The relay according to claim 14, wherein the error-proof mounting member of the relay voltage input connection structure and the housing of the relay are of an integrally formed structure.

16. The relay according to claim 14, further comprising a load terminal, wherein the load terminal is at least partially arranged within the housing.

17. The relay according to claim 16, wherein the housing comprises:
a bottom plate;
a first side plate perpendicularly arranged on the bottom plate, the load terminal is at least partially led out from the first side plate; and
a second side plate perpendicularly arranged on the bottom plate, the second side plate is adjacent to and perpendicular to the first side plate,
wherein the error-proof mounting member of the relay voltage input connection structure is arranged on the second side plate.

18. The relay according to claim 17, wherein the second side plate is provided with a recessed portion, and the error-proof mounting member is arranged in the recessed portion.

19. The relay voltage input connection structure according to claim 2, wherein the connector assembly further comprises a plurality of signal lines arranged along a first direction, and the plurality of signal lines are correspondingly plugged into the signal plugging through holes along a second direction and electrically connected to the plurality of relay coil pins;
wherein the first direction and the second direction are perpendicular to each other.
